(19) United States
(12) Patent Application Publication
(10) Pub. No.: US 2025/0237757 A1
(43) Pub. Date: Jul. 24, 2025

(54) DETERMINING DISTANCE AND DIRECTION TO A WIRELESS DEVICE

(71) Applicant: Samsung Electronics Co., Ltd., Suwon-si (KR)

(72) Inventors: Rebal Jurdi, Allen, TX (US); Guanbo Chen, McKinney, TX (US); Yuming Zhu, Plano, TX (US)

(21) Appl. No.: 19/019,304

(22) Filed: Jan. 13, 2025

Related U.S. Application Data
(60) Provisional application No. 63/622,923, filed on Jan. 19, 2024.

(51) Int. Cl. G01S 13/76

(52) U.S. Cl. CPC G01S 13/765

(57) ABSTRACT

A station (STA) in a wireless network comprising a memory and a processor coupled to the memory. The STA obtains, for a first step, a range distance to a target STA, a cumulative step size from a reference step and a first step heading. The STA determines a differential heading between the first step heading and a second step heading at a second step preceding the first step, based on a determination that a tracking filter is initialized. The STA predicts a first state using the tracking filter, based on the cumulative step size and, the differential heading. The STA updates the predicted first state using an estimator, based on the range distance. The STA determines a second state using an estimator, based on the updated predicted first state. The STA estimates a distance to the target STA and a direction to the target STA based on the second state.

### CROSS REFERENCE TO RELATED APPLICATION

This application claims benefit of U.S. Provisional Application No. 63/622,923, entitled “Determining Distance and Direction to Wireless Device and Resolving Flip Ambiguity,” filed on Jan. 19, 2024, in the United States Patent and Trademark Office, the entire contents of which are hereby incorporated by reference.

### TECHNICAL FIELD

This disclosure relates generally to a wireless communication system, and more particularly to, for example, but not limited to, positioning and trajectory in wireless communication systems.

### BACKGROUND

Over the past decade, indoor positioning has surged in popularity, driven by the increasing number of personal wireless devices and the expansion of wireless infrastructure. Various indoor positioning applications have emerged, spanning smart homes, buildings, surveillance, disaster management, industry, and healthcare, all demanding broad availability and precise accuracy. However, traditional positioning methods often suffer from limitations such as inaccuracy, impracticality, and scarcity. Ultra-wideband (UWB) technology has been adopted for indoor positioning. While UWB offers great accuracy, it lacks widespread adoption of UWB devices for use as ranging anchor points, unlike Wi-Fi, which is ubiquitous in commercial and residential environments. With Wi-Fi access points and stations pervading most spaces, indoor positioning using Wi-Fi has emerged as a preferred solution.

The description set forth in the background section should not be assumed to be prior art merely because it is set forth in the background section. The background section may describe aspects or embodiments of the present disclosure.

### SUMMARY

An aspect of the disclosure provides a station (STA) in a wireless network. The STA comprises a memory and a processor. The processor is coupled to the memory. The processor is configured to cause obtaining, for a first step, a range distance to a target STA, a cumulative step size from a reference step and a first step heading. The processor is further configured to cause determining a differential heading between the first step heading and a second step heading at a second step preceding the first step, based on a determination that a tracking filter is initialized. The processor is further configured to cause predicting a first state using the tracking filter, based on the cumulative step size and the differential heading. The processor is further configured to cause updating the predicted first state using an estimator, based on the range distance. The processor is further configured to cause determining a second state using an estimator, based on the updated predicted first state. The processor is further configured to cause estimating a distance to the target STA and a direction to the target STA based on the second state.

In an embodiment, the processor is further configured to cause determining that the tracking filter is not initialized. The processor is further configured to cause estimating the distance to the target STA using a non-tracking filter based on the range distance. The processor is further configured to cause retrieving a distance to the target STA that is obtained at the second step. The processor is further configured to cause estimating the direction to the target STA based on the estimated distance to the target STA that is obtained at the first step, the distance to the target STA that is obtained at the second step and the cumulative step size.

In an embodiment, the processor is further configured to cause initializing the tracking filter with the range distance and a bimodal direction, wherein the bimodal direction comprises a direction of a first mode and a direction of a second mode.

In an embodiment, the processor is further configured to cause initializing the tracking filter with the estimated distance and a bimodal direction, wherein the bimodal direction comprises a direction of a first mode and a direction of a second mode.

In an embodiment, the processor is further configured to cause initializing the tracking filter with an initializing distribution and a bimodal direction comprising a direction of a first mode and a direction of a second mode. The initializing distribution is a distribution of distances to the target STA and the initializing distribution has a mean or medium indicating the range distance or the estimated distance.

In an embodiment, the direction of the first mode is the opposite of the estimated direction and the direction of the second mode is the estimated direction.

In an embodiment, the processor is further configured to cause assuming that the target STA moves in a straight line when estimating the distance to the target STA.

In an embodiment, the processor is further configured to cause generating a particle set comprising two or more particles, each particle includes a distance to the target STA and a direction to the target STA. The processor is further configured to cause sampling the first state from a previous particle set according to weights associated with the previous particle set, wherein the weights indicate the likelihood of an occurrence of the first state. The processor is further configured to cause sampling an input step size from a step size distribution. The processor is further configured to cause sampling an input step heading from a step heading distribution. The processor is further configured to cause updating the sampled first state based on a sampled third state that precedes the sampled first state from the previous particle set, the sampled input step size and the sampled input step heading. The processor is further configured to cause determining a state weight for the updated sampled first state that indicates the likelihood of an occurrence of the updated sampled first state. The processor is further configured to cause updating the particle set to include a particle associated with the state weight comprising the updated sampled first state. The processor is further configured to cause determining the second state using an estimator, based on the updated sampled first state and the sampled state weight.

In an embodiment, the updating the sampled first state comprises determining a distance to the target STA of sampled first state based on a distance to the target STA of the sampled third state, the sampled input step size, a direction to the target STA of the sampled third state and a sampled input differential heading, wherein the sampled input differential heading is determined based on the sampled input step heading and a sampled step heading that precedes the sampled input stead heading. The updating the sampled first state further comprises determining a direction of the sampled first state based on the distance to the target STA of the sampled first state, the distance to the target STA of the sampled third state, the sample input step size, the direction of the sampled third state and the sample input differential heading. The updating the sampled first state further comprises determining a size of a detected step and a heading of the detected step based on the sampled input step size, a sampled input differential heading and an additive noise.

In an embodiment, the processor is further configured to cause monitoring for straight line motion based on the first step heading. The processor is further configured to cause monitoring for a bimodality of angle distribution, wherein the bimodality indicates whether the target STA changes direction. The processor is further configured to cause prompting the user to make a sharp left turn or a sharp right turn if bimodality is detected and if straight line motion is detected for a predetermined duration.

An aspect of the disclosure provides a method performed by a station (STA). The method comprises obtaining, for a first step, a range distance to a target STA, a cumulative step size from a reference step and a first step heading. The method further comprises determining a differential heading between the first step heading and a second step heading at a second step preceding the first step, based on a determination that a tracking filter is initialized. The method further comprises predicting a first state using the tracking filter, based on the cumulative step size and the differential heading. The method further comprises updating the predicted first state using an estimator, based on the range distance. The method further comprises determining a second state using an estimator, based on the updated predicted first state. The method further comprises estimating a distance to the target STA and a direction to the target STA based on the second state.

In an embodiment, the method further comprises determining that the tracking filter is not initialized. The method further comprises estimating the distance to the target STA using a non-tracking filter based on the range distance. The method further comprises retrieving a distance to the target STA that is obtained at the second step. The method further comprises estimating the direction to the target STA based on the estimated distance to the target STA that is obtained at the first step, the distance to the target STA that is obtained at the second step and the cumulative step size.

In an embodiment, the method further comprising initializing the tracking filter with the range distance and a bimodal direction, wherein the bimodal direction comprises a direction of a first mode and a direction of a second mode.

In an embodiment, the method further comprising initializing the tracking filter with the estimated distance and a bimodal direction, wherein the bimodal direction comprises a direction of a first mode and a direction of a second mode.

In an embodiment, the method further comprises initializing the tracking filter with an initializing distribution and a bimodal direction comprising a direction of a first mode and a direction of a second mode. The initializing distribution is a distribution of distances to the target STA and the initializing distribution has a mean or medium indicating the range distance or the estimated distance.

In an embodiment, the direction of the first mode is the opposite of the estimated direction and the direction of the second mode is the estimated direction.

In an embodiment, the method further comprises assuming that the target STA moves in a straight line when estimating the distance to the target STA.

In an embodiment, the method further comprises generating a particle set comprising two or more particles, each particle includes a distance to the target STA and a direction to the target STA. The method further comprises sampling the first state from a previous particle set according to weights associated with the previous particle set, wherein the weights indicate the likelihood of an occurrence of the first state. The method further comprises sampling an input step size from a step size distribution. The method further comprises sampling an input step heading from a step heading distribution. The method further comprises updating the sampled first state based on a sampled third state that precedes the sampled first state from the previous particle set, the sampled input step size and the sampled input step heading. The method further comprises determining a state weight for the updated sampled first state that indicates the likelihood of an occurrence of the updated sampled first state. The method further comprises updating the particle set to include a particle associated with the state weight comprising the updated sampled first state. The method further comprises determining the second state using an estimator, based on the updated sampled first state and the state weight.

In an embodiment, the updating the sampled first state comprises determining a distance to the target STA of sampled first state based on a distance to the target STA of the sampled third state, the sampled input step size, a direction to the target STA of the sampled third state and a sampled input differential heading, wherein the sampled input differential heading is determined based on the sampled input step heading and a sampled step heading that precedes the sampled input stead heading. The updating the sampled first state further comprises determining a direction of the sampled first state based on the distance to the target STA of the sampled first state, the distance to the target STA of the sampled third state, the sample input step size, the direction of the sampled third state and the sample input differential heading. The updating the sampled first state further comprises determining a size of a detected step and a heading of the detected step based on the sampled input step size, a sampled input differential heading and an additive noise.

In an embodiment, the method further comprises monitoring for straight line motion based on the first step heading. The method further comprises monitoring for a bimodality of angle distribution, wherein the bimodality indicates whether the target STA changes direction. The method further comprises prompting the user to make a sharp left turn or a sharp right turn if bimodality is detected and if straight line motion is detected for a predetermined duration.

Device-based zone identification provides for indoor positioning which permits controlling smart home features, tracking of assets endowed with wireless transceivers within buildings and emergency response finding individuals within a building or warehouse down to the room/zone level aiding in rescue efforts.

### BRIEF DESCRIPTION OF THE DRAWINGS

FIG. 1 shows an example of a wireless network in accordance with an embodiment.

FIG. 2A shows an example of access point (AP) in accordance with an embodiment.

FIG. 2B shows an example of station (STA) in accordance with an embodiment.

FIG. 3 shows an example of distance measurements in accordance with an embodiment.

FIG. 4 shows an example scenario depicting trilateration in accordance with an embodiment.

FIG. 5 shows an example scenario of flip ambiguity in accordance with an embodiment.

FIG. 6 shows an example scenario depicting necessary signaling to compute the ToF in accordance with an embodiment.

FIG. 7 shows an example scenario depicting necessary signaling to compute RTT in accordance with an embodiment.

FIG. 8 shows an example scenario depicting obtaining distance by inverting the RSSI in accordance with an embodiment.

FIG. 9 shows an example scenario depicting a fine timing measurement (FTM) session in accordance with an embodiment.

FIG. 10 shows an example scenario of the direction from a locator STA to a target STA relative to the direction of motion in accordance with an embodiment.

FIG. 11 shows an example scenario demonstrating flip ambiguity in accordance with an embodiment.

FIG. 12 shows an example scenario demonstrating flip ambiguity where the locator STA makes a sharp right turn in accordance with an embodiment.

FIG. 13 shows an example scenario demonstrating resolving flip ambiguity where the locator STA makes a sharp right turn in accordance with an embodiment.

FIG. 14 shows an example scenario demonstrating determination of the distance to the target STA and the direction to the target STA in accordance with an embodiment.

FIG. 15 shows an example scenario demonstrating determination of the distance to the target STA and the direction to the target STA if the target STA were on the opposite side in accordance with an embodiment.

FIG. 16 shows an example scenario depicting a user interface of the solution in accordance with an embodiment.

FIG. 17 shows a flowchart of operations resolving flip ambiguity in accordance with an embodiment.

FIG. 18 shows an example scenario of distance and direction finding after resolving flip ambiguity in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

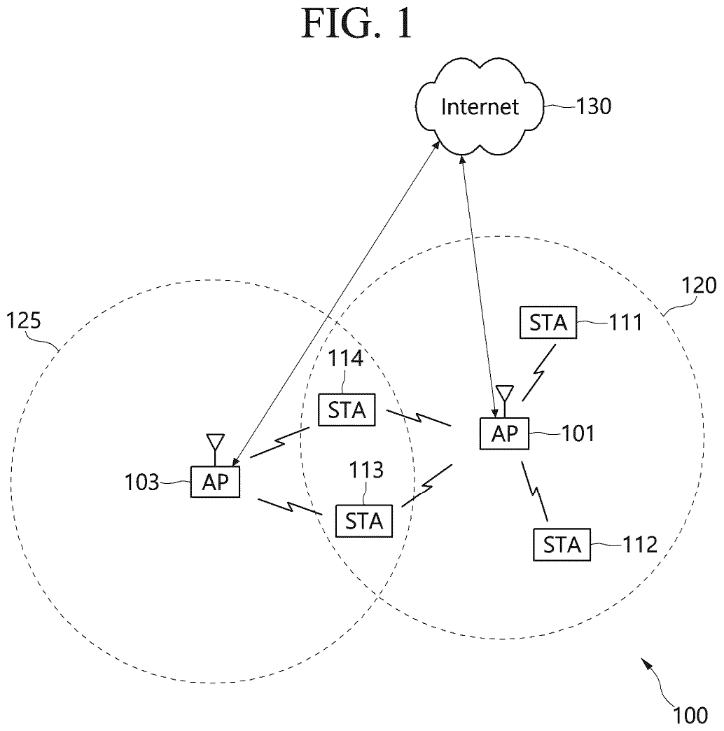

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

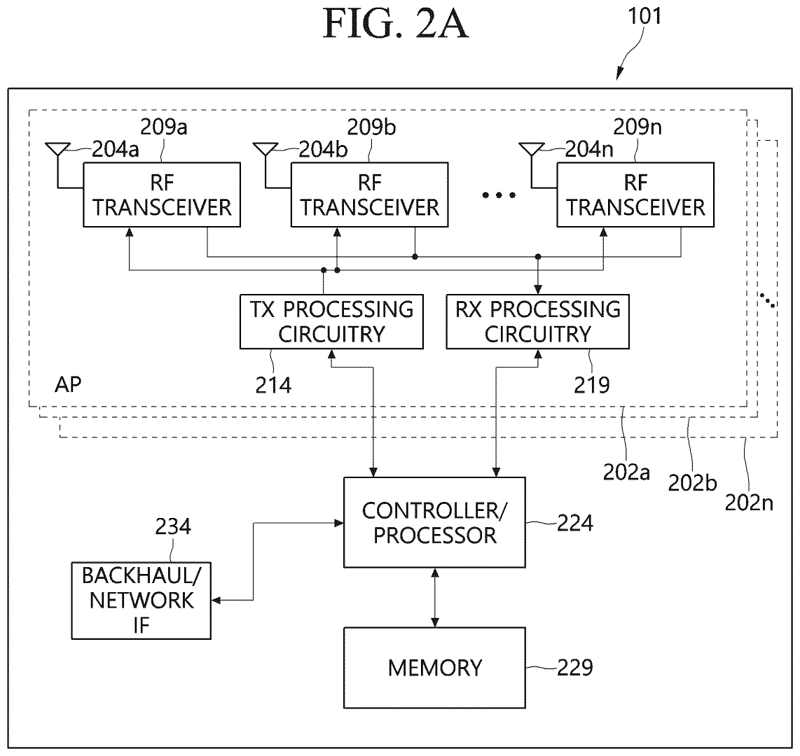

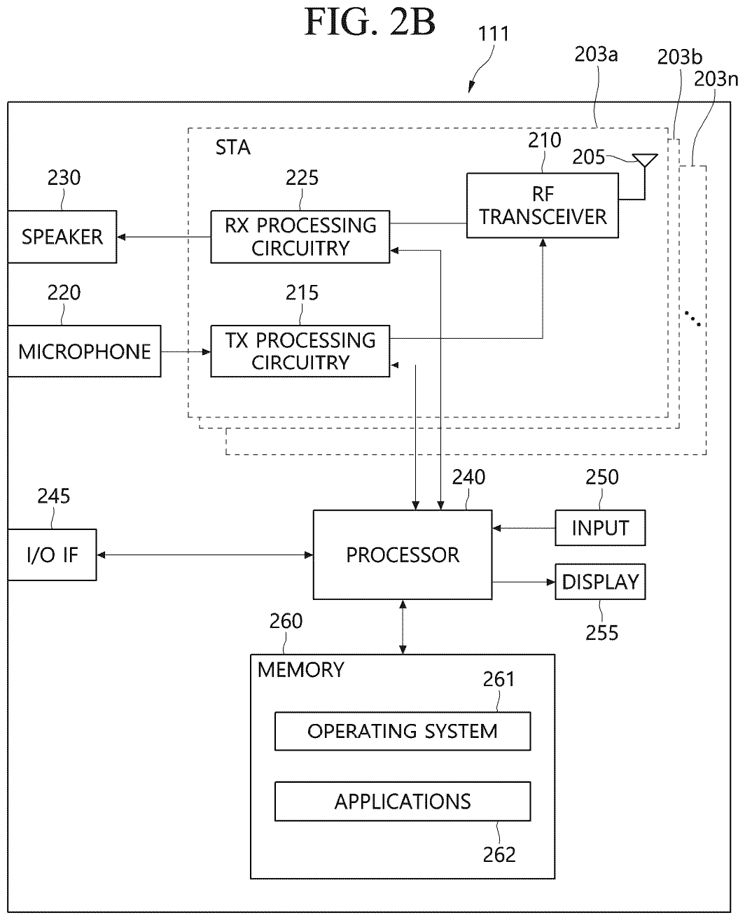

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

In this disclosure, devices and stations (STAs) may be used interchangeably to refer to the target device for which measurements are being determined. Similarly, access points and anchor points (APs) may be used interchangeably to refer to the devices used to gather measurements based on the target device.

The objective of a direction finding problem is to estimate the angle between the user's motion heading and a target object. The target object may be a wireless device capable of ranging with another wireless device on the user, being capable of performing back-and-forth signaling to measure the distance between the two devices. A user may find a lost device or person by use of such ranging abilities.

Flip ambiguity is a problem when the sidedness of an object of interest is ambiguous. Flip ambiguity is also a fundamental mathematical problem in positioning (or localization) that occurs when the number of measurements needed to localize an object is too small. In positioning, the objective is to estimate the position of target device with respect to a set of reference points, or anchor points, with known positions given the pairwise distances between the target and the anchor points.

A target device may be anywhere on a circle center around an anchor point with just one range measurement, such as distance measurement r corresponding to one anchor point. A target device may be at one of two possible locations where there are two range measurements r₁ and r₂ with two anchor points. The target device may be at one of the two intersection points of the two circles. Depending on the frame of reference, the two candidate points may be discerned as either the one on the left and the one on the right, the one at the top and one at the bottom, or similar vocabulary. The target device may be on the left side when in fact it is on the right side (the flip side).

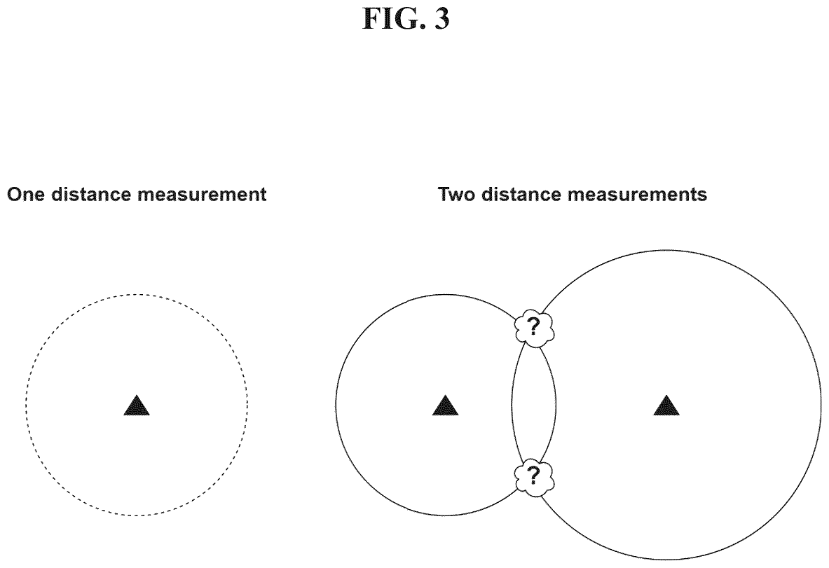

FIG. 3 shows an example of distance measurements in accordance with an embodiment. The example depicted in FIG. 3 is for explanatory and illustration purposes. FIG. 3 does not limit the scope of this disclosure to any particular implementation.

Referring to FIG. 3, there is a triangle point surrounded by a circle comprising dashed lines representing an anchor point and its coverage range, representing an example of an one distance measurement. There are two triangle points surrounded by two circles comprising dashed lines. The two circles intersect one another at two points representing the flip ambiguity in two distance measurements.

Therefore, a requirement for the absence of flip ambiguity in the absence of measurement noise is a minimum of three measurements from non-co-located anchor points in two-dimensional positioning, and four measurements in three-dimensional positioning. With enough measurements, position can be accurately estimated using common positioning techniques such as trilateration, as shown in the figure below.

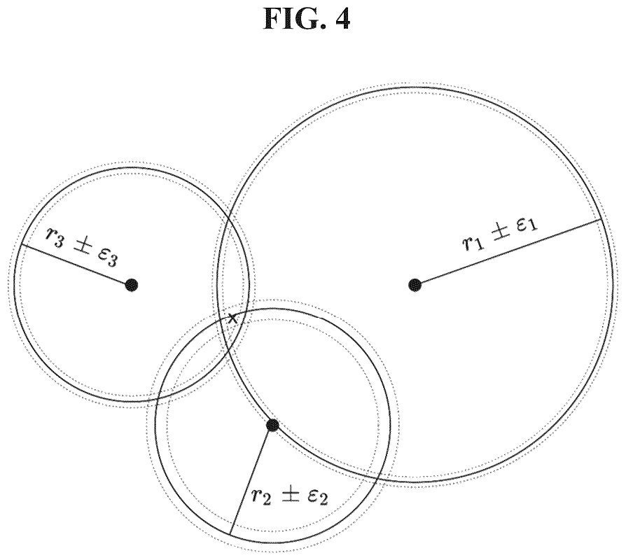

FIG. 4 shows an example scenario depicting trilateration in accordance with an embodiment. The example depicted in FIG. 4 is for explanatory and illustration purposes. FIG. 4 does not limit the scope of this disclosure to any particular implementation.

Referring to FIG. 4, there are three APs represented by points, the position of a STA represented by an X and three circles. The circles are each centered around one of the three APs. The circles have a radius determined by r±ε based on the positions of the AP and the STA. The circles intersect each other and the position X of the STA resides in an area intersected by all circles.

Physical anchor points (APs), such as WiFi access points, ultra-wide band (UWB) tags, and Bluetooth beacons, may be used as reference points to localize a device wielded by a user (target STA). A user may be located by locating the target STA. Similarly, virtual APs may be obtained by sampling the trajectory of the target STA. Additionally, the virtual APs may be used to localize a hidden STA. The use of virtual APs may also be susceptible to flip ambiguity as the underlying mathematical formulation and solution are identical to those of the physical APs.

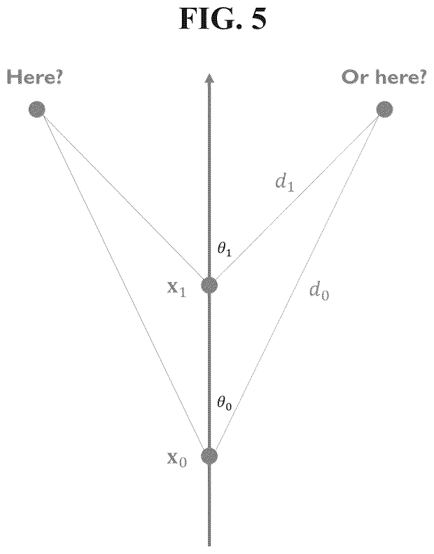

A target STA may be localized using other measurements in addition to range (distance) measurements. Some solutions also use a measure of the angle between a coordinate axis and the line connecting a reference point with the target STA. A target STA may be localized by one range measurement and one angle measurement. However, the angle measurement may lack an indicator, and so flip ambiguity prevails again as shown in FIG. 5.

FIG. 5 shows an example scenario of flip ambiguity in accordance with an embodiment. The example depicted in FIG. 5 is for explanatory and illustration purposes. FIG. 5 does not limit the scope of this disclosure to any particular implementation.

Referring to FIG. 5, on a line with two points, x₀ and x₁, two intersections points are determined based on localization of a target STA using two distance measurements, d₀ and d₁, and two angles, θ₀ and θ₁, where each angle is the angle between the line which x₀ and x₁ lie on and the lines of length d₀ and d₁ respectively. Flip ambiguity is demonstrated by the first intersection point being indicated by the term “Here?” and the second intersection point being indicated by the term “Or here?”.

### Distance Measurement

A wireless device may measure its distance to a reference device through a ranging mechanism. Measured quantities that may be converted to distance include time of flight (ToF), round-trip time (RTT) and signal strength (RSSI). These measured quantities may be converted to distance regardless of the wireless technology. Ranging may also be performed by non-wireless ranging technologies including optical (laser) ranging.

The time of flight (ToF) is determined by one device, typically an anchor point (AP), transmitting a message to the target device, for example a station (STA), embedding the timestamp t₁ at which the message was sent. The target STA receives the message, decodes it, timestamps its reception at t₂, and determines the ToF and corresponding STA-AP distance as shown in Equation 1.

$$r = c * ( {t}_{1} - {t}_{2} ) \qquad Equation 1$$

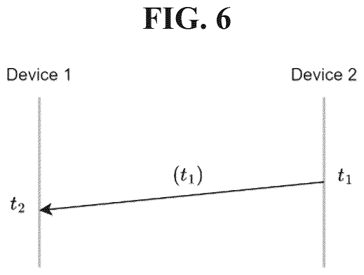

FIG. 6 shows an example scenario depicting necessary signaling to compute the ToF in accordance with an embodiment. The example depicted in FIG. 6 is for explanatory and illustration purposes. FIG. 6 does not limit the scope of this disclosure to any particular implementation.

Referring to FIG. 6, Device 1 and Device 2 are STAs. Device 2 transmits a message to Device 1 at t₁. The message comprises t₁, in addition to its other contents. Device 1 receives the message from Device 2 at t₂.

Trilateration is a standard method in range-based positioning. In trilateration, the target STA measures its distance from at least 3 APs to estimate its two-dimensional position. The target STA determines its position as the intersection of 3 or more circles centered around the APs. The radius of the circles may be the corresponding STA-AP distance. Where there are more than 3 APs, the method is known as multi-lateration. Other methods for determining position from range measurements exist. For example, Bayesian filtering, also known as the Kalman filter, is a more sophisticated method for determining from range measurements. The ranging mechanism to compute time of flight computation is standardized by UWB in IEEE 802.15.4z as one-way ranging (OWR).

The round-trip time (RTT) is determined by one device, typically the target STA, transmitting an empty message to an AP and timestamps the transmission time t₁. The AP receives the message, timestamps the reception time t₂, transmits a message to the target STA in response. The AP timestamps the transmission time as t₃ and embeds the t₂ and t₃ in the message. Subsequently, the target STA receives the message embedded with t₂ and t₃, timestamps the reception time t₄, and decodes the two timestamps. The target STA determines the round-trip time based on t₁, t₂, t₃, t₄ and the STA-AP distance as shown in Equation 2.

$$r = c * ( {t}_{4} - {t}_{1} - {t}_{3} + {t}_{2} ) / 2 \qquad Equation 2$$

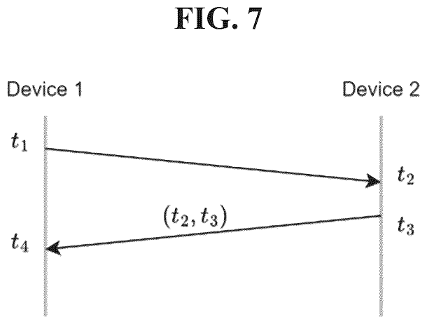

FIG. 7 shows an example scenario depicting necessary signaling to compute RTT in accordance with an embodiment. The example depicted in FIG. 7 is for explanatory and illustration purposes. FIG. 7 does not limit the scope of this disclosure to any particular implementation.

Referring FIG. 7, Device 1 and Device 2 are STAs. Device 1 transmits a first message to Device 2 at t₁. Device 2 receives the first message at t₂. Subsequently, Device 2 transmits a second message to Device 1 at t₃. The message comprises t₂ and t₃. Device 1 receives the second message at t₄.

In addition to the operations discussed above for the method for determining two-dimensional position of the target STA, RTT may be used to determine the STA-AP distance instead of ToF. This mechanism is standard in UWB under IEEE 802.15.4z, known is two-way ranging (TWR), and in WiFi under IEEE 802.11mc, known as fine timing measurement (FTM).

The received signal strength indicator (RSSI) is determined as the received power at a STA of interest by the transmit power an AP less propagation losses that are a function of the STA-AP distance. Using a standard propagation model, for example the International Telecommunication Union (ITU) indoor propagation model for WiFi, or a propagation model fitted on empirical data, the RSSI may be converted to generate a distance. One common model is the one-slope linear model expressing the relationship between RSSI and distance as shown in Equation 3.

$$RSSI = β + α \cdot log d \qquad Equation 3$$

In Equation 3, α and β are fitting parameters. Following the inversion of RSSIs to generate distances, standard positioning methods, for example trilateration that turn a set of distance measurements to a single position may be applied.

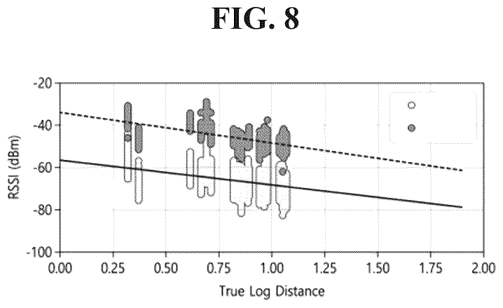

FIG. 8 shows an example scenario depicting obtaining distance by inverting the RSSI in accordance with an embodiment. The example depicted in FIG. 8 is for explanatory and illustration purposes. FIG. 8 does not limit the scope of this disclosure to any particular implementation.

Referring to FIG. 8, the first RSSI and the second RSSI are inverted generating the STA-AP distance. The first RSSI is represented by a solid line. The first RSSI corresponds to the collection of grey dots. The second RSSI is represented by a dashed line. The second RSSI corresponds to the collection of black dots.

The channel state information (CSI) is determined by a STA determining the channel frequency response or the channel impulse response. The channel impulse response expresses how the environment affects different frequency components in terms of both their magnitude and their phase. Monitoring the changes in phase over time and over a range of frequencies can be used to compute the STA-AP distance, and a wide range of methods, the details of which are beyond the scope of this document, exist for that purpose, for example multi-carrier phase difference used with Bluetooth low energy.

### Pedestrian Dead Reckoning (PDR)

Dead reckoning is a method of estimating the position of a moving object using the object's last known position by adding incremental displacements to that last known position. Pedestrian dead reckoning, or PDR, refers specifically to the scenario where the object in question is a pedestrian walking in an indoor or outdoor space. With the proliferation of sensors inside smart devices, such as smartphones, tablets, and smartwatches, PDR has naturally evolved to supplement wireless positioning technologies that have been long supported by these devices such as WiFi and cellular service, as well as more recent and less common technologies such as ultra-wide band (UWB). The inertial measurement unit (IMU) is a device that combines numerous sensors with functional differences, such as the accelerometer measures linear acceleration; the gyroscope measures angular velocity; and the magnetometer measures the strength and direction of the magnetic field. These three sensors may estimate the trajectory of the device. Combining IMU sensor data and ranging measurements from wireless chipsets such as WiFi and UWB, or sensor fusion, may improve positioning accuracy by reducing uncertainty.

Sensors in the wireless device's IMU are no longer the sole source for step detection and movement tracking on smart devices. Due to the more recent proliferation of applications such as virtual reality, augmented reality, and autonomous driving, indoors (robotics) and outdoors, cameras are increasingly being used to track the position and orientation of objects in the environment including the very object they are attached to through a technique called visual inertial odometry. This has opened the door to positioning and tracking methods based on computer vision, including simultaneous localization and mapping (SLAM), structure from motion (SfM), and image matching.

### Fine Timing Measurement (FTM)

Fine Timing Measurement (FTM) is a wireless network management procedure defined in IEEE 802.11-2016 (unofficially known to be defined under 802.11mc) that allows a WiFi station (STA), to accurately measure the distance from other STAs such as an access point or an anchor point (AP) by measuring the RTT between the two. An STA wanting to localize itself, known as the initiating STA, with respect to other STAs, known as responding STAs, schedules an FTM session during which the STAs exchange messages and measurements. The FTM session consists of three phases: negotiation, measurement exchange, and termination.

In the negotiation phase, the initiating STA may negotiate key parameters with the responding STA, such as frame format, bandwidth, number of bursts, burst duration, burst period, and number of measurements per burst. The negotiation may start when the initiating STA sends an FTM request frame, which is a management frame with subtype Action, to the responding STA. The FTM request frame may be called the initial FTM request frame. This initial FTM request frame may include the negotiated parameters and their values in the frame's FTM parameters element. The responding STA may respond with an FTM frame called initial FTM frame, which approves or overwrites the parameter values proposed by the initiating STA.

The measurement phase consists of one or more bursts, and each burst consists of one or more (Fine Time) measurements. The duration of a burst and the number of measurements therein are defined by the parameters burst duration and FTMs per burst. The bursts are separated by interval defined by the parameter burst duration. In the negotiation phase, the initiating STA negotiates with the responding STA key parameters, such as frame format and bandwidth, number of bursts, burst duration, the burst period, and the number of measurements per burst.

In the termination phase, an FTM session terminates after the last burst instance, as indicated by parameters in the FTM parameters element.

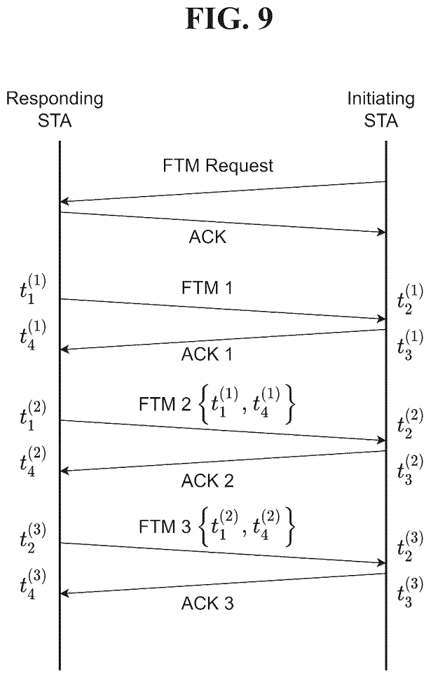

FIG. 9 shows an example scenario depicting an FTM session in accordance with an embodiment. In the example of FIG. 9, the FTM session includes one burst and three FTMs per burst.

Referring to FIG. 9, the initiating STA transmits an Initial FTM Request frame to the responding STA triggering the start of the FTM session. The responding STA transmits an acknowledgement block (ACK) to the initiating STA. Subsequently, the responding STA transmits the first FTM frame to the initiating STA and captures its transmission time t₁⁽¹⁾. The initiating STA receives the first FTM frame and captures its reception time t₂⁽¹⁾. The initiating STA transmits an ACK and captures its transmission time t₃⁽¹⁾. The responding STA receives the ACK from the initiating STA and captures its reception time t₄⁽¹⁾. The responding STA transmits a second FTM frame to the initiating STA and captures its transmission time t₁⁽²⁾. The initiating STA receives the second FTM frame and captures it reception time t₂⁽²⁾. The two STAs continue to exchange FTM frames and ACKs for as many measurements as were negotiated between the two STAs.

The second FTM frame in FIG. 9 serves two purposes. The second Frame is a follow-up to the first FTM frame and is used to transfer timestamps t₁⁽¹⁾ and t₄⁽¹⁾ recorded by the responding STA and the second Frame starts a second measurement. The initiating STA decodes the second FTM frame to generate the timestamps t₁⁽¹⁾ and t₄⁽¹⁾. Subsequently, the initiating STA determines RTT based on applying offset adjustments shown in Equation 4.

$$R T T = ( {t}_{4}^{( 1 )} - {t}_{1}^{( 1 )} ) - ( {t}_{3}^{( 1 )} - {t}_{2}^{( 1 )} ) \qquad Equation 4$$

A distance d is determined from the RTT of Equation 4 for positioning and proximity applications as shown in Equation 5.

$$d = \frac{R T T}{2} c \qquad Equation 5$$

Each FTM of the burst will yield a distance sample, with multiple distance samples per burst. A representative distance measurement may be determined by combining distance samples derived from multiple FTM bursts and multiple measurements per burst. For example, the mean distance, the median or some other percentile may be reported. Furthermore, other statistics such as the standard deviation could be reported as well to be used by the positioning application.

### Trilateration

Trilateration is a method to determine the position of an object, in space or on a plane, using distances, or ranges, between the STA and 3 or more (multi-lateration) reference points, or anchor points (APs) with known locations. The distance between the STA and an AP can be measured directly, or indirectly as a physical quantity of time that is then converted into a distance. Two examples of such physical quantities are the ToF of a radio signal from the AP to the STA (or the opposite), and the RTT between the AP and the STA. Given there are three or more ranges, one with every AP, the position of the STA is determined as the intersection of three circles, each centered at one of the three APs.

Determining the position of the STA may be done by different methods, either linear or non-linear. A common method is to define a non-linear least squares problem with the following objective function; as shown in Equation 6.

$$F ( p ) = F ( x , y , z ) = {\sum }_{a = 1}^{A} {f}_{a}^{2} ( p ) \qquad Equation 6$$

In Equation 6, fₐ(p) is the distance between the STA, currently at a position p, and AP a. The position p* would then be obtained by minimizing the objective function F(p) using general methods, for example Gauss-Newton or Levenberg-Marquardt.

In the case of a moving STA, a tracking algorithm from the Bayesian framework may be used to estimate the object's position at different points in time. The STA's anticipated trajectory may be expressed through a motion model, also known as a transition model. The STA's observed trajectory may also be expressed through a measurement model, or an observation model. The object's position may then be recursively determined from applying a two-step process to the measurements. The first step is the prediction step. In the prediction step, the position may be predicted solely from the motion model. The second step is the update step. In the update step, measurements may be used to correct the predicted position. The Bayesian filter may be implemented as a particle filter, also known as Monte-Carlo localization, grid-based filter, among many other implementations. If the motion and measurement models are linear, then the linear and efficient Kalman filter may be used. If the models may be easily linearized, then the extended Kalman filter may be used.

### Bayesian Filter

The Bayesian framework is a mathematical tool used to estimate the state of an observed dynamic system or its probability. In this framework, the trajectory of the system is represented by a motion model, also known as a state transition model, which describes how the system evolves over time. The measurement of a state is expressed through a measurement model or an observation model, which relates the state or its probability at a given time to measurements collected at that time. With an incoming stream of measurements, the state of the system is recursively estimated in two stages, measurement by measurement. In the first stage, known as the prediction stage, the state at a point in the near future is predicted solely using the motion model. In the second stage, known as the update stage, measurements are used to correct the prediction state. The successive application of the prediction stage and update stage gives rise to what is known as the Bayesian filter. Mathematical details are provided below.

The motion model describes the evolution of the state of the system and relates the current state to the previous state. There are two ways to express the relationship: direct relationship and indirect relationship.

In the direct relationship, the new (next) state xₖ may be expressed as a random function of the previous state xₖ₋₁ and input to the system uₖ as shown in Equation 7.

$${x}_{k} = f ( {u}_{k} , {x}_{k - 1} ) \qquad Equation 7$$

Indirect relationship: a transition kernel may be provided as shown in Equation 8.

$$p ( {x}_{k} \vert {x}_{k - 1} , {u}_{k} ) \qquad Equation 8$$

Measurement Model relates the current observation to the current state. Similarly, there are two ways to express this relationship: direct relationship and indirect relationship.

In the direct relationship, the observation yₖ may be expressed as a random function of the current state Xx as shown in Equation 9.

$${y}_{k} = g ( {x}_{k} ) \qquad Equation 9$$

In the indirect relationship, the likelihood distribution may be provided as shown in Equation 10.

$$p ( {y}_{k} \vert {x}_{k} ) \qquad Equation 10$$

Initially, the Bayesian filter starts with a belief b₀(x₀)=p(x₀) about the state of the system at the very beginning. At each time index k, the Bayesian filter refines the belief of state of system by applying the prediction stage followed by the update stage. The state of the system can then be estimated from the belief, as the minimum mean square error estimate (MMSE), the maximum a posteriori estimate (MAP), or other methods.

In the Prediction stage, the Bayesian filter determines ‘a priori’ belief bₖ⁻(sₖ) using the state transition model as shown in Equation 11.

$${b}_{k}^{-} ( {s}_{k} ) = \int \int {b}_{k - 1} ( s ) p ( s \vert {s}_{k - 1} , {u}_{k} ) d s \qquad Equation 11$$

In the updated stage, the Bayesian filter updates ‘a posteriori’ belief bₖ(sₖ) using the measurement model as shown in Equation 12.

$${b}_{k} ( {s}_{k} ) = {b}_{k}^{-} ( {s}_{k} ) \cdot p ( {y}_{k} \vert {s}_{k} ) \qquad Equation 12$$

Once the ‘a posteriori’ belief has been determined, the state can be estimated in various ways as shown in Equations 13 and 14.

$${\hat{s}}_{k}^{M A P} = {arg max}_{s} {b}_{k} ( s ) \qquad Equation 13$$

$${\hat{s}}_{k}^{MMSE} = \int \int {b}_{k} ( s ) d s \qquad Equation 14$$

### The Solution

There are three key issues with existing solutions. There is a power constraint. The power constraint reduces coverage, including reducing the effective distance of coverage. There is a hardware constraint in terms of the number of antennas on either device. This hardware constraint prevents angle-of-arrival/angle-of-departure algorithms from being utilized, allowing flip ambiguity to take place. There is a privacy constraint. The privacy constraint is a result of the device's camera being required to be turned on during operations.

The solution described in this disclosure comprises the following features. The solution may detect flip ambiguity and seamlessly overcome the flip ambiguity. The solution may be used with any wireless technology, such as WiFi, UWB, or Bluetooth, and any form of range measurement, such as ToF, RTT, or RSSI. The solution may not require a camera to be on for it to work with IMU.

The solution further comprises a tracking filter that estimates the distance and direction from the user to the target object from two inputs. The first input may be the range measurements with the target. The second input may be the measurements of the user's displacements.

The solution may be deployed on a wireless device held by the user (locator STA) and one that can (wirelessly) range with the target device (target STA). Parts of the solution may run on a local or remote server, or on the cloud.

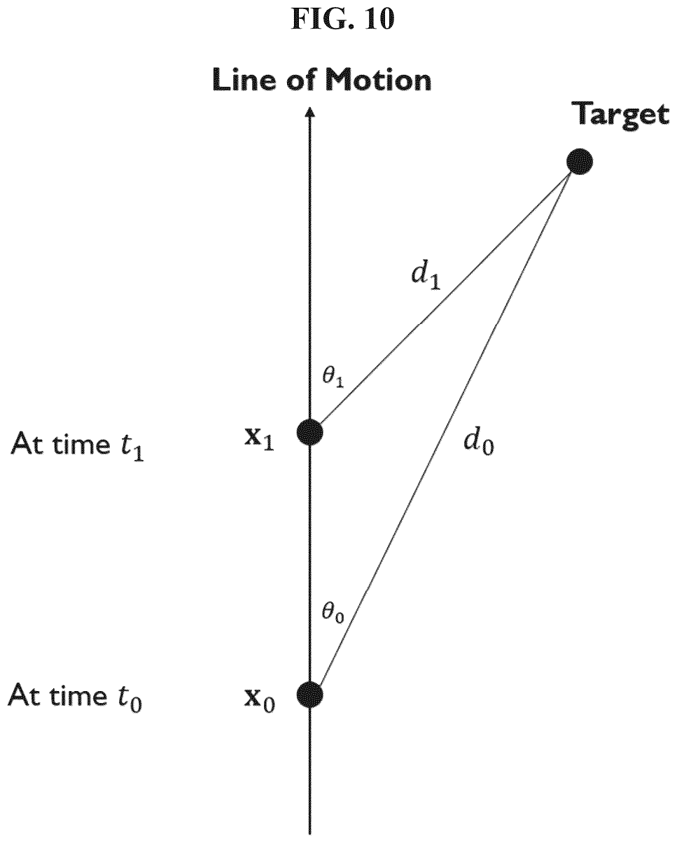

FIG. 10 shows an example scenario of the direction from a locator STA to a target STA relative to the direction of motion in accordance with an embodiment.

Referring to FIG. 10, the Line of Motion represents the direction of the locator STA moving in a straight line to the north. The positions x₀ and x₁ are the position of the locator STA at the times t₀ and t₁ respectively. The distances d₀ and d₁ are the resulting distances measured from ranging between the locator STA and the target STA at times t₀ and t₁ respectively. The angles θ₀ and θ₁ are the angles from the direction of the locator STA to the target STA at the times t₀ and t₁ respectively.

The locator STA may determine the angle by applying the generalized Pythagoras theorem as shown in Equation 15 and Equation 16.

$${d}_{0}^{2} = {‖ Δ {x}_{1} ‖}^{2} + {d}_{1}^{2} - 2 ‖ Δ {x}_{1} ‖ {d}_{1} cos ( π - {θ}_{1} ) \qquad Equation 15$$

$$cos {θ}_{1} = \frac{{d}_{0}^{2} - {d}_{1}^{2} - {‖ Δ {x}_{1} ‖}^{2}}{2 {d}_{1} ‖ Δ {x}_{1} ‖} \qquad Equation 16$$

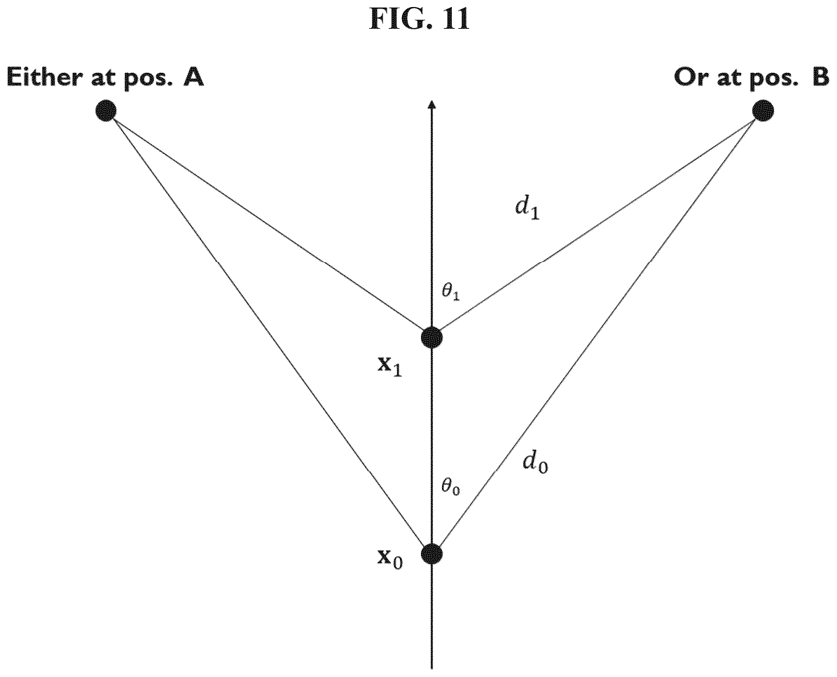

FIG. 11 shows an example scenario demonstrating flip ambiguity in accordance with an embodiment.

Referring to FIG. 11, the Line of Motion represents the direction of the locator STA moving in a straight line to the north. The positions x₀ and x₁ are the position of the locator STA. The distances d₀ and d₁ are the resulting distances from the locator STA to the target STA. The angles θ₀ and θ₁ are the angles from the direction of the locator STA to the target STA. The position of the target STA is uncertain however and may be on either side of the Line of Motion, at position A on the west side or at position B on the east side.

The locator STA may be moving facing the target STA or may be moving with its back turned to the target STA. When the locator STA is moving facing the target STA, the locator STA may determine the distance d₀ as shown in Equation 17 and the direction θ₁ as being zero or straight. When the locator STA is moving with its back turned to the target STA, the locator STA may determine the distance d₁ as shown in Equation 18 and the direction θ₁ as being π or backwards.

$${d}_{0} = ‖ Δ {x}_{1} ‖ + {d}_{1} \qquad Equation 18$$

$${d}_{1} = ‖ Δ {x}_{1} ‖ + {d}_{0} \qquad Equation 19$$

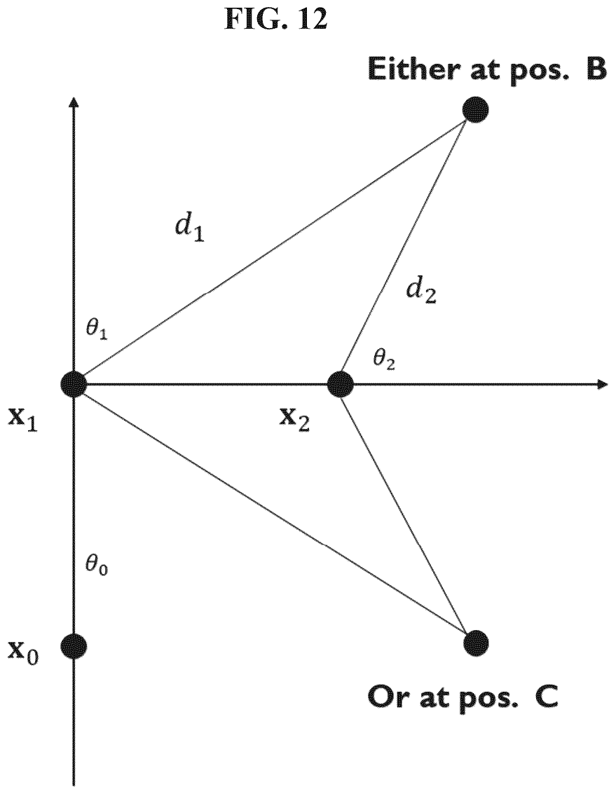

FIG. 12 shows an example scenario demonstrating flip ambiguity where the locator STA makes a sharp right turn in accordance with an embodiment.

Referring to FIG. 12, the locator STA is now moving east. The positions x₀, x₁ and x₂ are the positions of the locator STA. The distances d₁ and d₂ are the resulting distances from the locator STA to the target STA. The angles θ₀, θ₁ and θ₂ are the angles from the direction of the locator STA to the target STA. The position of the target STA is uncertain and may be on either side of the new line of motion, at position B north of the line of motion or at position C south of the line of motion.

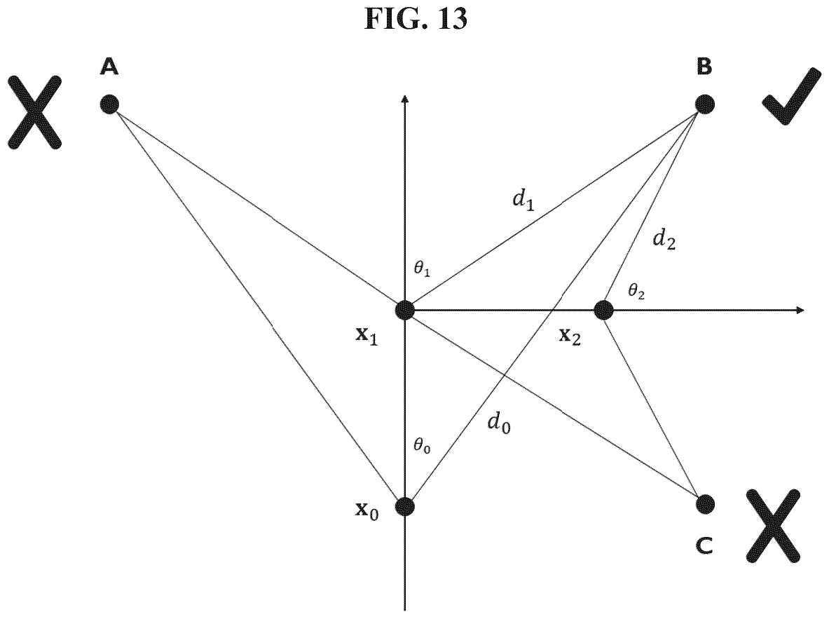

FIG. 13 shows an example scenario demonstrating resolving flip ambiguity where the locator STA makes a sharp right turn in accordance with an embodiment.

Referring to FIG. 13, the locator STA is now moving east. The positions x₀, x₁ and x₂ are the positions of the locator STA. The distances d₀, d₁ and d₂ are the resulting distances from the locator STA to the target STA. The angles θ₀, θ₁ and θ₂ are the angles from the direction of the locator STA to the target STA. The position of the target STA is certain because when moving north, the target STA is at either position A or position B and when moving east, the target STA is at either position B or position C. Since the movement of the locator STA should not change the location of the of the target STA, the target STA must be located at position B.

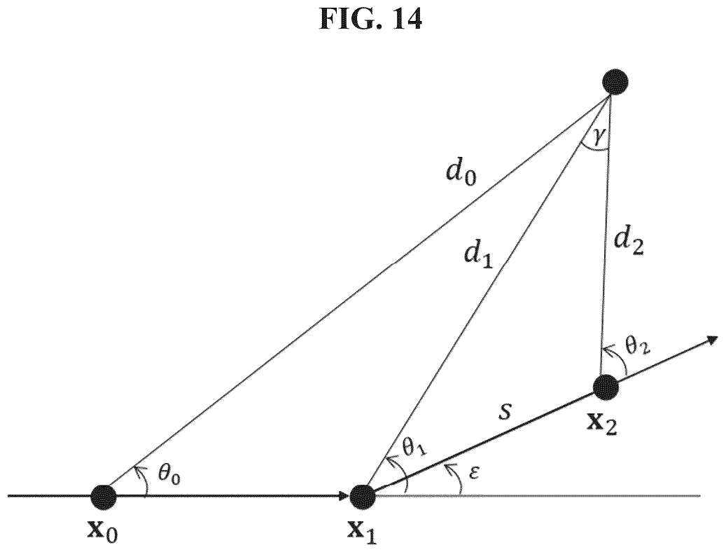

FIG. 14 shows an example scenario demonstrating determination of the distance to the target STA and the direction to the target STA in accordance with an embodiment.

Referring to FIG. 14, the locator STA is now moving θ₂ north of east. The positions x₀, x₁ and x₂ are the positions of the locator STA. The distances d₀, d₁ and d₂ are the resulting distances from the locator STA to the target STA. The distance s is the step size. The angles θ₀, θ₁ and θ₂ are the angles from the direction of the locator STA to the target STA. The differential heading ∈ is the difference between the headings ϕ₁ and ϕ₂ at x₁ and x₂ where ∈=ϕ₂−ϕ₁. The position of the target STA is certain and may be determined.

The distance to the target STA d₂ may be determined as shown in Equation 20.

$${d}_{2} = \sqrt{{d}_{1}^{2} + {s}^{2} - 2 {d}_{1} s cos ( {θ}_{1} - ϵ )} \qquad Equation 20$$

The direction to the target STA θ₂ may be determined as shown in Equation 21 with Equation 22. The old direction relative to the new motion axis becomes θ₁′ as shown in Equation 23.

$${θ}_{2} = {θ}_{1}^{′} + γ = {θ}_{1} - ϵ + γ \qquad Equation 21$$

$$γ = arccos ( \frac{{d}_{2}^{2} + {d}_{1}^{2} - {s}^{2}}{2 {d}_{1} {d}_{2}} ) \qquad Equation 22$$

$${θ}_{1}^{′} = - ε + {θ}_{1} = {θ}_{1} - ϵ \qquad Equation 23$$

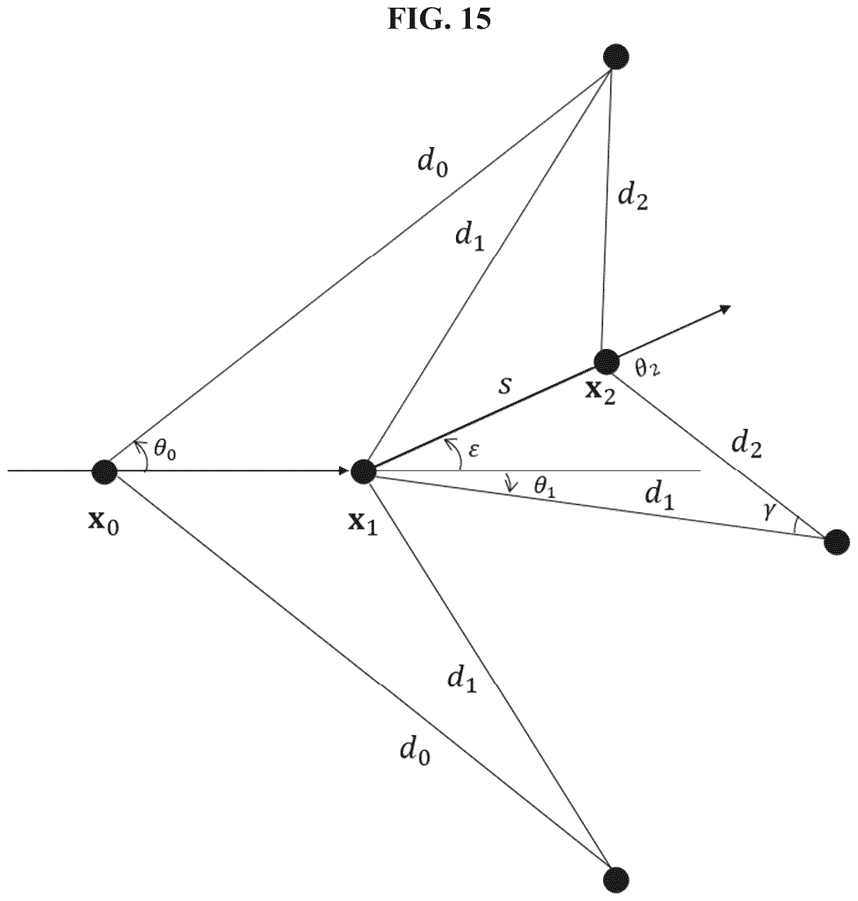

FIG. 15 shows an example scenario demonstrating determination of the distance to the target STA and the direction to the target STA if the target STA were on the opposite side in accordance with an embodiment.

Referring to FIG. 15, the locator STA is now moving θ₂ north of east. The positions x₀, x₁ and x₂ are the positions of the locator STA. The distances d₁ and d₂ are the resulting distances from the locator STA to the target STA. The distance s is the step size. The angles θ₀, θ₁ and θ₂ are the angles from the direction of the locator STA to the target STA. The differential heading ∈ is the difference between the headings ϕ₁ and ϕ₂ at x₁ and x₂ where ∈=ϕ₂−ϕ₁. The position of the target STA is certain and may be determined.

The distance to the target STA d₂ may be determined as shown in Equation 20. The direction to the target STA θ₂ may be determined as shown in Equation 21. The equations for determining the distance and direction are immune to effects of flip ambiguity.

Wireless technologies, such as WiFi, Bluetooth, and UWB, may provide different types of measurements from which distance may be inferred. Wireless technologies may, for example and without limitation, provide for time of flight (ToF) measurements, round trip time (RTT) measurements or received signal strength indicator (RSSI) measurements.

The solution may convert ToF measurements and RTT measurements to a distance by direct scaling. The underlying wireless subsystem may have already scaled the measurement to a distance. The solution may convert RSSI into a range measurement by applying an inverse function that maps RSSI back into a distance. The inverse function may be an analytical, indoor propagation model taking multiple parameters, such as channel frequency or bandwidth. The inverse function may also be an analytical, multivariate model fit empirically to collected data. The inverse function may also be a machine learning model trained on collected data.

The composite state sₖ is defined as sₖ=(dₖ, θₖ), where dₖ is the true distance from the target STA, and θₖ is the direction, or angle, with the target STA. Specifically, θ is the angle between the motion vector and the vector extending from the locator STA towards the target STA. For example, and without limitation, the target STA is straight ahead of the locator STA when θ=0°. The target STA is right behind the locator STA when θ=180°. The target STA is to the right side of the locator STA when θ<0. The target STA is to the right side of the locator STA θ>0.

The solution may assume that it knows the trajectory of the locator STA when engaged in distance- and direction-finding. The locator STA's trajectory may be provided via a sequence of steps taken by the locator STA, each with a size z and a heading ϕ. The sequence of steps taken by the locator STA, or its trajectory in general, may be inferred from the inertial measurement unit (IMU) of the locator STA. The locator STA may use sensors like the accelerometer providing linear acceleration readings. The locator STA may use the gyroscope providing rotational velocity. The locator STA may use the magnetometer reading the magnetic field and providing a sense of absolute direction. Alternatively, the locator STA may infer the trajectory from the cameras of the locator STA using any of the plethora of tracking and positioning algorithms using compute vision, such as ARToolKit. The details of trajectory estimation from inertial or visual sensors is beyond the scope of this disclosure.

### Motion Model

A motion model, also known as the transition model, may describe the distance from the target dₖ and the direction with it θₖ evolve with time. The relationship between the distance at the kth time step dₖ and that at the previous time step dₖ₋₁ is defined as shown in Equation 24.

$${d}_{k} = \sqrt{{d}_{k - 1}^{2} + {z}_{k}^{2} - 2 {d}_{k - 1} {z}_{k} cos ( {θ}_{k - 1} - {ε}_{k} )} \qquad Equation 24$$

In Equation 24, the \tilde{z}ₖ is the measured size of the cumulative step, such as the total length of displacement since the last time step and εₖ is the corresponding change in heading.

The relationship between the direction at the kth time step θₖ and that at the previous time step θₖ₋₁ is defined as shown in Equation 25.

$${θ}_{k} = {θ}_{k - 1} - {ε}_{k} + arccos ( \frac{{d}_{k}^{2} + {d}_{k - 1}^{2} - {z}_{k}^{2}}{2 {d}_{k} {d}_{k - 1}} ) \qquad Equation 25$$

### Measurement Model

A measurement model, also known as an observation model, describes how the measurement relates to the state at the same time step as shown in Equation 26.

$${r}_{k} = {d}_{k} + {w}_{k} \qquad Equation 26$$

In Equation 26, rₖ is the measured range at time step k and wₖ is the additive measurement noise. Unlike the distance to the target STA, the direction with the target STA is not measured.

The solution, within the Bayesian framework, produces the state estimate ŝₖ=(\hat{d}ₖ, θₖ) every time step k by computing the belief bₖ(sₖ) of the true state sₖ recursively from the sequence of range measurements at these time steps {rₖ} and step size and (differential) heading inputs {uₖ=(zₖ, εₖ)}. In the differential heading inputs, zₖ is the size of the kth step and εₖ is the differential heading angle, the rotation angle from the existing line of motion.

The times at which an estimate is to be produced (estimation epochs) may coincide with the time at which a range measurement is received, such that an estimate for each range is obtained. The estimation epochs may coincide with the time at which a step is detected. The estimation epochs may be periodic where the period is a time duration. The estimation epochs may be periodic where the period is an integer number of range measurements. The estimation epochs may be periodic where the period is an integer number of detected steps.

The solution may comprise many processes performed by the locator STA. The locator STA may perform the processes described in the following paragraphs.

The cumulative step may be the first step performed by the locator STA. The locator STA may perform the cumulative step since the last time step, which accounts for the total length of displacement zₖ, accumulated over multiple steps, and the corresponding heading ϕₖ, where the heading of the last time step is ϕₖ₋₁. The locator STA may then determine the differential heading εₖ as the difference between the current heading and the heading of the last time step or εₖ=ϕₖ−ϕₖ₋₁.

The processing step may be the second step performed by the locator STA. A tracking filter is supposed to estimate and track the evolution of the distance from the locator STA to the target STA and the direction from the locator STA to the target STA. If the tracking filter is initialized then the locator STA may skip the processing step and the initialization step described below. The locator STA may perform the prediction step after the cumulative step if it skips the processing step and the initialization step. The locator STA may process the range rₖ through a filter, such as Kalman filter, simple moving average, or exponential moving average. The locator STA may determine the distance \hat{d}ₖ as the output of the filter. The locator STA may indicate that the direction angle is not available yet.

The initialization step may be the third step performed by the locator STA. The locator STA may initialize the tracking filter if a step is detected in the current time step and if the number of steps detected so far Nₖ>N* for some integer N*. The locator STA determines the distance estimate \hat{d}ₖ, to initialize the state of the tracking filter. The distance estimate \hat{d}ₖ, may correspond to the prior detected step at time step k′. The locator STA may determine the angle θ* as shown in Equation 27. The locator STA may set the initial distribution for dₖ to be deterministic with the value rₖ. Alternatively, the locator STA may set the initial distribution to be deterministic with the value \hat{d}ₖ. Furthermore, the locator STA may set the distribution of dₖ to be any random value whose mean or median is either rₖ, \hat{d}ₖ, or a function thereof. The locator STA may set the initial distribution for θₖ to be bimodal with modes at −θ* and θ*.

$${θ}^{*} = arccos ( \frac{{\hat{d}}_{{k}^{′}}^{2} - {\hat{d}}_{k}^{2} - {z}_{k}^{2}}{2 {\hat{d}}_{k} {z}_{k}} ) \qquad Equation 27$$

The prediction step may be the fourth step performed by the locator STA. The locator STA may determine a predicted state sₖ by determining its a priori distribution bₖ⁻(sₖ) using the state transition model as shown in Equation 28.

$${b}_{k}^{-} ( {s}_{k} ) = \int \int {b}_{k - 1} ( s ) p ( s \vert {s}_{k - 1} , {u}_{k} ) ds \qquad Equation 28$$

The update step may be the fifth step performed by the locator STA. The locator STA may update the state distribution by determining its a posteriori distribution bₖ(sₖ) using the measurement model as shown in Equation 29.

$${b}_{k} ( {s}_{k} ) = {b}_{k}^{-} ( {s}_{k} ) \cdot p ( {r}_{k} \vert {s}_{k} ) \qquad Equation 29$$

The estimation step may be the sixth step performed by the locator STA. The locator STA may determine the state through the minimum-means square (MMSE), maximum-a-posteriori (MAP), or other estimators, as shown in Equation 30 and Equation 31.

$${\hat{s}}_{k}^{MAP} = {arg max}_{s} {b}_{k} ( s ) \qquad Equation 30$$

$${\hat{s}}_{k}^{MMSE} = \int \int {b}_{k} ( s ) ds \qquad Equation 31$$

The unwrapping state step may be the seventh step performed by the locator STA. The locator STA may unwrap the state estimate ŝₖ to obtain the estimates of the distance to the target and estimates of the direction angle with it as shown in Equation 32.

$${\hat{s}}_{k} = ( {\hat{d}}_{k} , \hat{ε} ) \qquad Equation 32$$

The monitoring step may be the eighth step performed by the locator STA. The locator STA may monitor the heading of the trajectory and look for straight-line motion. Straight-line motion may be defined as motion made of contiguous, back-to-back steps of the same heading. The locator STA may also monitor the bimodality of the angle distribution. The locator STA may use commonly used techniques such as binning or kernel smoothing when checking whether a distribution is bimodal. The locator STA may prompt the user to walk in a straight line. The locator STA may prompt the user to make a sharp turn, such as a right-angle turn, then continue walking if bimodality is detected, and if straight-line motion has been ongoing for a duration of T_{STLM}.

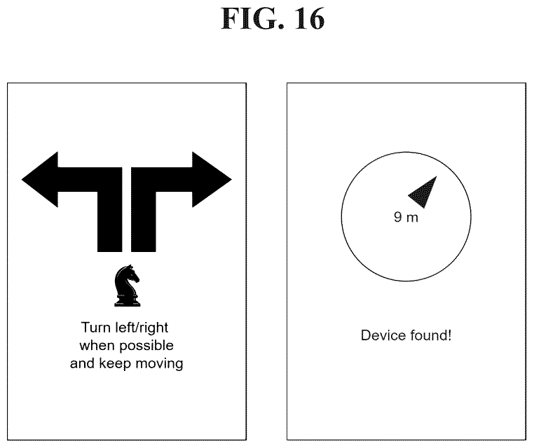

FIG. 16 shows an example user interface in accordance with an embodiment.

Referring to FIG. 16, there is an interface shown depicting a leftmost figure and a rightmost figure. The leftmost figure shows a locator STA, such as a smart phone, asking the user to make a turn to the right or to the left, when possible, and to continue moving. The locator STA may resolve the ambiguity in the direction of the device in this way by detecting a bimodal angle distribution. The rightmost figure shows a locator STA indicating that the target STA has been found after ambiguity has been resolved.

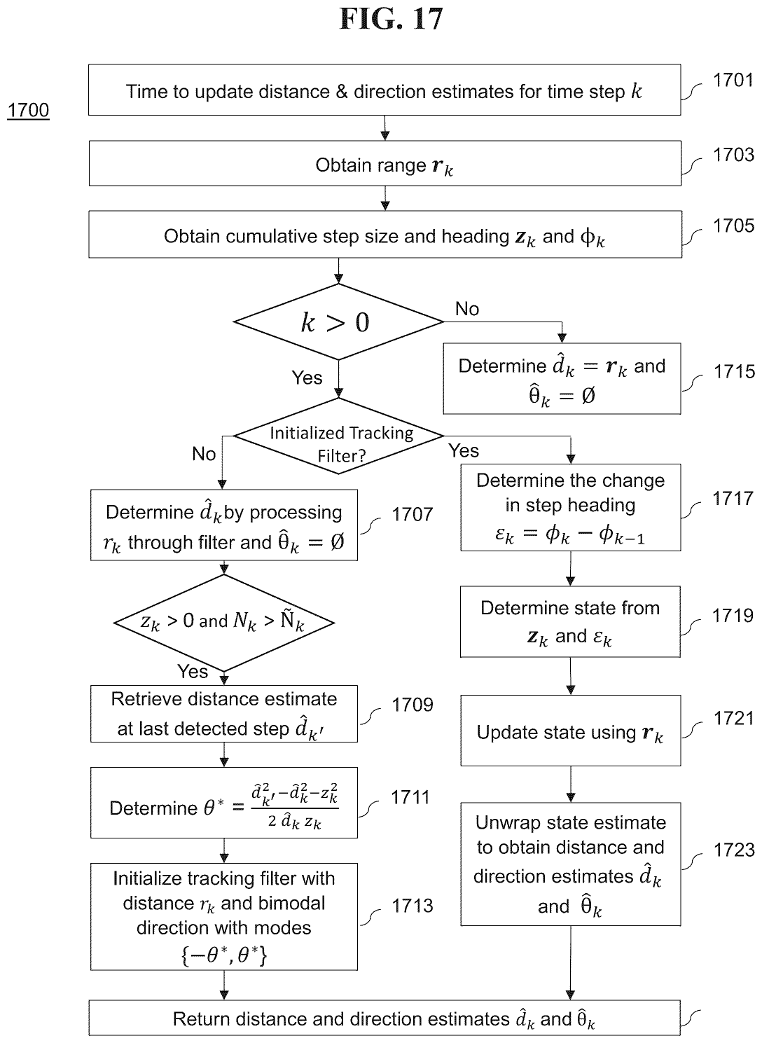

FIG. 17 shows a flowchart of operations resolving flip ambiguity in accordance with an embodiment.

Referring to FIG. 17, resolving flip ambiguity, process 1700, begins at operation 1701. In operation 1701, the locator STA determines that it is time to update the distance and direction estimate for the time step k.

In operation 1703, the locator STA obtains the range rₖ.

In operation 1705, the locator STA obtains the cumulative step size zₖ and cumulative step heading ϕₖ. Operation 1705 is followed by operation 1707 if k>0 and if the locator STA has not initialized a tracking filter. Operation 1705 is followed by operation 1715 if k≤0. Operation 1705 is followed by operation 1717 if k>0 and if the locator STA has initialized a tracking filter.

In operation 1707, the locator STA determines \hat{d}ₖ by processing rₖ through a filter and setting the direction \hat{θ}ₖ=Ø. Operation 1707 is followed by operation 1109 if zₖ>0 and Nₖ>Ñₖ.

In operation 1709, the locator STA retrieves the distance estimate at the last detected time step \hat{d}_{k′}.

In operation 1711, the locator STA determines that the direction

$${θ}^{*} = \frac{{\hat{d}}_{{k}^{′}}^{2} - {\hat{d}}_{k}^{2} - {z}_{k}^{2}}{2 {\hat{d}}_{k} {z}_{k}} .$$

In operation 1713, the locator STA initializes a tracking filter with distance rₖ and bimodal direction with modes {−θ*, θ*}.

In operation 1715, the locator STA determines the distance \hat{d}ₖ=rₖ and the direction \hat{θ}ₖ=Ø.

In operation 1717, the locator STA determines the charge in step heading where the step heading εₖ=ϕₖ−ϕₖ₋₁.

In operation 1719, the locator STA determines the current state based on zₖ and εₖ.

In operation 1721, the locator STA updates the state using the range rₖ.

In operation 1723, the locator STA unwraps state estimate to obtain distance estimate \hat{d}ₖ and direction estimate \hat{θ}ₖ.

In operation 1725, the locator STA returns the distance estimate \hat{d}ₖ and the direction estimate \hat{θ}ₖ to the target STA.

### Particle Filter

The Bayesian filter may be implemented as a particle filter. A locator STA using the particle filter may capture the distribution of the state with a set of particles and a corresponding set of weights. Each particle of the set has two values. The first value is for distance and the second value is for direction. The set of weights reflects probability or frequency. In this alternative solution, the initialization, prediction, update, and estimation steps are replaced as described below.

The locator STA may use an alternative initialization step. The alternative initialization step begins with a particle set Sₖ. The particle set Sₖ contains two particles. The first particle sₖ⁽⁰⁾ is determined as sₖ⁽⁰⁾=(rₖ, −θ*). The second particle sₖ⁽¹⁾ is determined as ₖ⁽¹⁾=(rₖ, θ*).

The locator STA may use an alternative prediction, update, and estimation. The locator STA may run the following steps every estimation time step.

The locator STA may sample states from the current (previous) particle set according to current weights as shown in Equation 33.

$$( {d}_{k - 1}^{( i )} , {θ}_{k - 1}^{( i )} ) = {s}_{k - 1}^{( i )} ∼ {S}_{k - 1} \qquad Equation 33$$

The locator STA may update every sampled state according to the state transition model as shown in Equation 34, Equation 35 and Equation 36.

$${d}_{k}^{( i )} = \sqrt{{d}_{k - 1}^{( i ) 2} + {z}_{k}^{2} - 2 {d}_{k - 1}^{( i )} {z}_{k} cos ( {θ}_{k - 1}^{( i )} - {ε}_{k} )} \qquad Equation 34$$

$${θ}_{k}^{( i )} = {θ}_{k - 1}^{( i )} - {ε}_{k} + arccos ( \frac{{d}_{k}^{( i ) 2} + {d}_{k - 1}^{( i ) 2} - {z}_{k}^{2}}{2 {d}_{k}^{( i )} {d}_{k - 1}^{( i )}} ) \qquad Equation 35$$

$$( {z}_{k} , {ε}_{k} ) = ( {\tilde{z}}_{k} , {\tilde{ε}}_{k} ) + {v}_{k} \qquad Equation 36$$

In Equation 36, vₖ is additive noise to simulate the error in the size and heading of the detected step.

The locator STA may determine a weight for every updated state as the likelihood of the observation as shown in Equation 37.

$${w}_{k}^{( i )} = p ( {r}_{k} \vert {s}_{k}^{( i )} ) \qquad Equation 37$$

The locator STA may add every new particle and its corresponding weight to the new particle set and normalize weights as shown in Equation 38.

$${S}_{k} = {S}_{k} ⋃ \{ ( {s}_{k}^{( i )} , {w}_{k}^{( i )} ) \} \qquad Equation 38$$

The locator STA may determine MAP and MMSE estimates as shown in Equation 39 and Equation 40.

$${\hat{s}}_{k}^{MMSE} = \sum {w}_{k}^{( i )} {s}_{k}^{( i )} \qquad Equation 39$$

$${\hat{s}}_{k}^{MAP} = {\hat{s}}_{k}^{{i}^{*}} ; {i}^{*} = arg {max}_{i} {w}_{k}^{i} \qquad Equation 40$$

An alternative to the locator STA is a grid-based filter, where the continuous support of the two-dimensional state s is replaced by an appropriate quantization to a finite support.

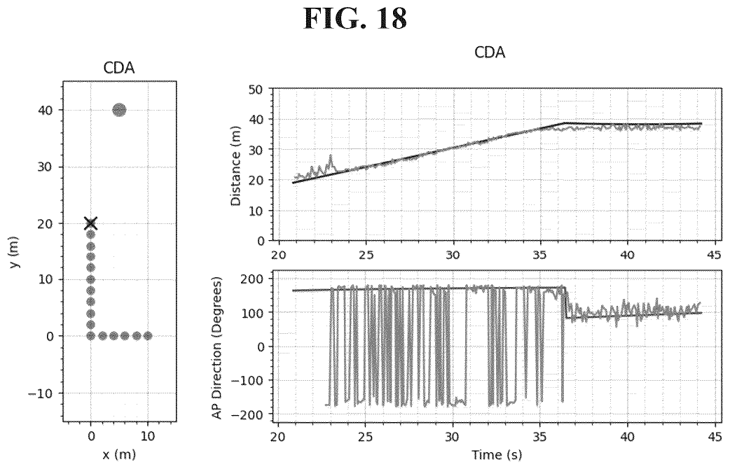

FIG. 18 shows an example scenario of distance and direction finding after resolving flip ambiguity in accordance with an embodiment.

Referring to FIG. 18, flip ambiguity is resolved after the locator STA prompts the user to make a sharp turn. The leftmost sub-figure shows the ground truth trajectory of the locator STA showing movement away from the locator STA. The top right sub-figure shows an estimated distance to the target STA and the ground truth distance as a function of time, where the ground truth distance is represented by a regular line and the estimated distance is represented by the irregular waved line. The bottom right sub-figure shows an estimated direction to the target STA and the ground truth distance as a function of time, where the ground truth distance is represented by a regular line and the estimated direction is represented by an irregular waved line.

The disclosure provides the ability to detect flip ambiguity seamlessly and overcome the flip ambiguity. The solution may be in any wireless technology, such as WiFi, UWB and Bluetooth and any form of range management such as ToF, RTT and RSSI. The solution does not require a camera to be on it and may still work with IMU.

According to various embodiments, a first STA requests, from an AP, a resource on behalf of a second STA so that AP will be able to efficiently allocate time (or TXOP) of the pending traffic from the first STA to the second or from the second STA to the first STA in their P2P communication, so that latency sensitive traffic may be delivered in a timely manner.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
obtaining, for a first step, a range distance to a target STA, a cumulative step size from a reference step and a first step heading;
determining a differential heading between the first step heading and a second step heading at a second step preceding the first step, based on a determination that a tracking filter is initialized;
predicting a first state using the tracking filter, based on the cumulative step size and the differential heading;
updating the predicted first state using an estimator, based on the range distance;
determining a second state using an estimator, based on the updated predicted first state; and
estimating a distance to the target STA and a direction to the target STA based on the second state.

2. The STA of claim 1, wherein the processor is further configured to cause:
determining that the tracking filter is not initialized;
estimating the distance to the target STA using a non-tracking filter based on the range distance;
retrieving a distance to the target STA that is obtained at the second step; and
estimating the direction to the target STA based on the estimated distance to the target STA that is obtained at the first step, the distance to the target STA that is obtained at the second step and the cumulative step size.

3. The STA of claim 2, wherein the processor is further configured to cause:
initializing the tracking filter with the range distance and a bimodal direction, wherein the bimodal direction comprises a direction of a first mode and a direction of a second mode.

4. The STA of claim 2, wherein the processor is further configured to cause:
initializing the tracking filter with the estimated distance and a bimodal direction, wherein the bimodal direction comprises a direction of a first mode and a direction of a second mode.

5. The STA of claim 2, wherein the processor is further configured to cause:
initializing the tracking filter with an initializing distribution and a bimodal direction comprising a direction of a first mode and a direction of a second mode,
wherein the initializing distribution is a distribution of distances to the target STA and the initializing distribution has a mean or medium indicating the range distance or the estimated distance.

6. The STA of claim 3, wherein:
the direction of the first mode is the opposite of the estimated direction; and
the direction of the second mode is the estimated direction.

7. The STA of claim 2, wherein the processor is further configured to cause:
assuming that the target STA moves in a straight line when estimating the distance to the target STA.

8. The STA of claim 2, wherein the processor is further configured to cause:
generating a particle set comprising two or more particles, each particle includes a distance to the target STA and a direction to the target STA;
sampling the first state from a previous particle set according to weights associated with the previous particle set, wherein the weights indicate the likelihood of an occurrence of the first state;
sampling an input step size from a step size distribution;
sampling an input step heading from a step heading distribution;
updating the sampled first state based on a sampled third state that precedes the sampled first state from the previous particle set, the sampled input step size and the sampled input step heading;
determining a state weight for the updated sampled first state that indicates the likelihood of an occurrence of the updated sampled first state;
updating the particle set to include a particle associated with the state weight comprising the updated sampled first state;
determining the second state using an estimator, based on the updated sampled first state and the state weight.

9. The STA of claim 8, wherein updating the sampled first state comprises:
determining a distance to the target STA of sampled first state based on a distance to the target STA of the sampled third state, the sampled input step size, a direction to the target STA of the sampled third state and a sampled input differential heading, wherein the sampled input differential heading is determined based on the sampled input step heading and a sampled step heading that precedes the sampled input stead heading;
determining a direction of the sampled first state based on the distance to the target STA of the sampled first state, the distance to the target STA of the sampled third state, the sample input step size, the direction of the sampled third state and the sample input differential heading; and
determining a size of a detected step and a heading of the detected step based on the sampled input step size, the sampled input differential heading and an additive noise.

10. The STA of claim 1, wherein the processor is further configured to cause:
monitoring for straight line motion based on the first step heading;
monitoring for a bimodality of angle distribution, wherein the bimodality indicates whether the target STA changes direction; and
prompting the user to make a sharp left turn or a sharp right turn if bimodality is detected and if straight line motion is detected for a predetermined duration.

11. A method performed by a station (STA), the method comprising:
obtaining, for a first step, a range distance to a target STA, a cumulative step size from a reference step and a first step heading;
determining a differential heading between the first step heading and a second step heading at a second step preceding the first step, based on a determination that a tracking filter is initialized;
predicting a first state using the tracking filter, based on the cumulative step size and the differential heading;
updating the predicted first state using an estimator, based on the range distance;
determining a second state using an estimator, based on the updated predicted first state; and
estimating a distance to the target STA and a direction to the target STA based on the second state.

12. The method of claim 11, further comprising:
determining that the tracking filter is not initialized;
estimating the distance to the target STA using a non-tracking filter based on the range distance;
retrieving a distance to the target STA that is obtained at the second step; and
estimating the direction to the target STA based on the estimated distance to the target STA that is obtained at the first step, the distance to the target STA that is obtained at the second step and the cumulative step size.

13. The method of claim 12, further comprising:
initializing the tracking filter with the range distance and a bimodal direction, wherein the bimodal direction comprises a direction of a first mode and a direction of a second mode.

14. The method of claim 12, further comprising:
initializing the tracking filter with the estimated distance and a bimodal direction, wherein the bimodal direction comprises a direction of a first mode and a direction of a second mode.

15. The method of claim 12, further comprising:
initializing the tracking filter with an initializing distribution and a bimodal direction comprising a direction of a first mode and a direction of a second mode,
wherein the initializing distribution is a distribution of distances to the target STA and the initializing distribution has a mean or medium indicating the range distance or the estimated distance.

16. The method of claim 13, wherein:
the direction of the first mode is the opposite of the estimated direction; and
the direction of the second mode is the estimated direction.

17. The method of claim 12, further comprising:
assuming that the target STA moves in a straight line when estimating the distance to the target STA.

18. The method of claim 12, further comprising:
generating a particle set comprising two or more particles, each particle includes a distance to the target STA and a direction to the target STA;
sampling the first state from a previous particle set according to weights associated with the previous particle set, wherein the weights indicate the likelihood of an occurrence of the first state;
sampling an input step size from a step size distribution;
sampling an input step heading from a step heading distribution;
updating the sampled first state based on a sampled third state that precedes the sampled first state from the previous particle set, the sampled input step size and the sampled input step heading;
determining a state weight for the updated sampled first state that indicates the likelihood of an occurrence of the updated sampled first state;
updating the particle set to include a particle associated with the state weight comprising the updated sampled first state;
determining the second state using an estimator, based on the updated sampled first state and the state weight.

19. The method of claim 18, wherein updating the sampled first state comprises:
determining a distance to the target STA of sampled first state based on a distance to the target STA of the sampled third state, the sampled input step size, a direction to the target STA of the sampled third state and a sampled input differential heading, wherein the sampled input differential heading is determined based on the sampled input step heading and a sampled step heading that precedes the sampled input stead heading;
determining a direction of the sampled first state based on the distance to the target STA of the sampled first state, the distance to the target STA of the sampled third state, the sampled input step size, the direction of the sampled third state and the sampled input differential heading; and
determining a size of a detected step and a heading of the detected step based on the sampled input step size, the sampled input differential heading and an additive noise.

20. The method of claim 11, further comprising:
monitoring for straight line motion based on the first step heading;
monitoring for a bimodality of angle distribution, wherein the bimodality indicates whether the target STA changes direction; and
prompting the user to make a sharp left turn or a sharp right turn if bimodality is detected and if straight line motion is detected for a predetermined duration.
